(19) United States
(12) Patent Application Publication
(10) Pub. No.: US 2005/0235292 A1
(43) Pub. Date: Oct. 20, 2005

(54) Client program grammar derivation from application programming interface (API) calls and associated metadata

(76) Inventors: Timothy Nephi Tillotson, Heber, UT (US); Sara Ting, Cupertino, CA (US); Nathan A. Berg, Fort Collins, CO (US); Ryan M. Kinney, Fort Collins, CO (US)

Correspondence Address: AGILIENT TECHNOLOGIES, INC.;Legal Department, DL429, Intellectual Property Administration, P.O. Box 7599, Loveland, CO, 80537-0599, US

(21) Appl. No.: 10/824,973

(22) Filed: Apr. 15, 2004

(51) Int. Cl. G06F 9/46

(52) U.S. Cl. 719/328

(57) ABSTRACT

An apparatus and method for obtaining a client program grammar communication from an Application Programming Interface (API) call. The API call is first obtained. When metadata is associated with the API call, the associated metadata is obtained and a best estimation of the client program grammar communication is obtained from the associated metadata and from the API call. Otherwise, a best estimation of the client program grammar communication is automatically obtained from the API call.

### BACKGROUND

Initially, electronic instruments were stand-alone units designed for rather limited and specific applications. Within the instrument industry, a wide variety of instrument command sets were developed which required instrument users to learn a new vocabulary for each instrument. This proliferation of command sets resulted in users spending a great deal of time learning how to program instruments, made maintenance of test programs difficult, and made it difficult to upgrade test systems as new equipment became available. In order to reduce development costs, various standard electrical and mechanical interfaces were developed for instruments and other electronic devices. With the advent of computer communication with and computer control of instruments and systems of instruments, standardized signal protocols and other standardized electrical and mechanical interfaces became more prevalent. These protocols were mainly intended to set standards for digital messages sent over these interfaces.

The Standard Commands for Programmable Instrumentation (SCPI) protocol standard was developed to define a set of commands for controlling programmable test and measurement devices in instrumentation systems. An instrumentation system is a collection of test and measurement devices connected by a communication bus to a control computer called the system controller. An instrumentation system may include stand-alone devices like IEEE 488 instruments or instrument cards in an enclosure such as a VXIbus rack.

Client processes often located on remote computers address commands, which may be, for example, a command to apply a signal, make a measurement, perform a calibration, or the like to one or more instruments over the bus. These commands are called program messages. Instruments may also send response messages back to the clients. The response messages may be measurement results, instrument settings, error messages, or the like. Prior to the SCPI standard, the commands that controlled a particular device function varied between instruments which had similar capabilities. SCPI provided a uniform and consistent language for the control of test and measurement instruments. The same commands and responses can control corresponding instrument functions in SCPI equipment, regardless of the supplier or the type of instrument.

For instance, the command to measure a frequency is the same whether the measurement is made by an oscilloscope or a counter. The set of commands to control multimeters from two manufacturers differs only in places where the underlying hardware has different capabilities. Thus, instruments from different vendors can be expected to be essentially interchangeable in many applications.

SCPI provides a means to perform simple operations. The MEAS (measure) command, for example, can configure and read data from an instrument. When the program message “:MEAS:VOLT:AC?” is received by a voltmeter, for example, the meter will select settings and configure its circuitry for an AC voltage measurement, initiate the measurement, and return the result to the system controller. The question mark at the end of the command instructs the voltmeter to return the measured value to the controller. As another example, the SCPI command “:MEAS:FREQ?” returns a frequency measurement from an oscilloscope or a counter, despite great internal differences in the hardware of the instruments.

SCPI commands are organized in hierarchical structures referred to as trees. In the above two commands, “MEAS” is a parent node in a SCPI tree while “VOLT” is one child node of that parent and “FREQ” is another child node.

A central feature of the SCPI standard is the Command Reference which is a list of definitions for all the program messages. These definitions specify precisely the syntax and semantics for every SCPI message. Instrument functions covered by the standard may only be controlled through SCPI commands. However, SCPI was designed with a modular structure that permits commands controlling new functions to be added at any time.

The Hewlett-Packard Interface Bus (HPIB) interface system, also known as the General-Purpose Interface Bus (GPIB) or by its Institute of Electrical and Electronic Engineers (IEEE) specification number, IEEE 488 is a scheme by which groups of devices may be connected to a controlling computer and communicate under its direction. Instruments from multiple vendors can be operated in the same HPIB system. SCPI commands can be implemented on an instrument using any sort of interface, as for example, HPIB, serial/RS-232, VXI backplane, or the like, but they are especially common on HPIB busses.

The IEEE 488.1 standard defines hardware for an instrumentation bus. It is a digital bus with lines for the serial transfer of data bytes, plus extra control and handshaking lines. The IEEE 488.2 is an additional standard that defines protocols for data/command exchange between controller and instruments, basic data formats, systematic rules for program messages, and definition of instrument status structures. IEEE 488.2 also defines some common commands covering instrument functions that are universally applicable. However, IEEE 488.2 does not define commands or data structures for specific applications. Instrument makers are free to define the commands that control the primary functions of their instruments. SCPI builds upon IEEE 488.2 by standardizing these primary functions.

.NET is an open software standard initially developed by Microsoft which is becoming more and more popular for use in developing applications for instruments and instrument systems in the test and measurement field. Since a large majority of test and measurement instruments and systems are connected to one or more computers and since .NET was developed primarily for use with computer controlled applications, NET has become a standard development platform for instruments and instrument systems. As such, .NET may well eventually replace SCPI as the application language of choice in a large number of instruments and instrument systems.

### SUMMARY

In representative embodiments, a method is disclosed for obtaining a client program grammar communication from an Application Programming Interface (API) call. The API call is first obtained. When metadata is associated with the API call, the associated metadata is obtained and a best estimation of the client program grammar communication is obtained from the associated metadata and from the API call. Otherwise, a best estimation of the client program grammar communication is automatically obtained from the API call.

In another representative embodiment, a system comprises a generator module configured to receive an Application Programming Interface (API) call. The generator module is further configured to obtain metadata when such metadata is associated with the API call and configured to automatically determine a best estimation of the client program communication from the API call and, when such metadata has been obtained, also from the associated metadata.

Other aspects and advantages of embodiments of the present invention will become apparent from the following detailed description, taken in conjunction with the accompanying drawings, illustrating by way of example the principles of the invention.

### BRIEF DESCRIPTION OF THE DRAWINGS

The accompanying drawings provide visual representations which will be used to more fully describe various representative embodiments and can be used by those skilled in the art to better understand them and their inherent advantages. In these drawings, like reference numerals identify corresponding elements.

FIG. 1 is a drawing of a block diagram of a measurement system as described in various representative embodiments.

FIG. 2 is a drawing of a system for the generation of Standard Commands for Programmable Instrumentation (SCPI) grammar from NET Application Programming Interface (API) calls as described in various representative embodiments.

FIG. 3 is a drawing of a block diagram of a data structure as described in various representative embodiments.

FIG. 4 is a drawing of a block diagram of another data structure as described in various representative embodiments.

FIG. 5 is a drawing of a flow chart of a method for generating Standard Commands for Programmable Instrumentation (SCPI) grammar from .NET Application Programming Interface (API) calls as described in various representative embodiments.

### DETAILED DESCRIPTION

As shown in the drawings for purposes of illustration, the present patent document relates to novel methods for the derivation of client program commands from Application Programming Interface (API) calls and associated metadata. The techniques disclosed herein generally apply to control languages or application frameworks used on an instrument or other electronic device that provide what is commonly referred to as having “reflection” capability. Reflection is a term that implies, among other things, that the framework has the ability to interrogate a program to determine the classes that the program contains and the methods, properties, events, and fields that those classes contain, as well as any parameters and return types.

In the past a large number of instrument applications, as well as the client programs accessing those instrument applications, were written using the Standard Commands for Programmable Instrumentation (SCPI) protocol. Many instrument users are familiar with SCPI and wish to continue programming in it. Currently, however, more and more new and updated instrument applications are being written with Application Programming Interface (API) calls in .NET which is an open software standard initially developed by Microsoft. Typically instrument users would prefer not to expend effort changing their programs from SCPI to .NET even though their programs may now be accessing applications which are written in NET. Further, as new NET API's representing, for example, new capabilities become available on instruments, the user may prefer to make appropriate modifications in SCPI to his control programs which interface with the instrument's NET API's rather than rewriting his programs in .NET protocol.

In representative embodiments, methods and apparatus for discovering and/or creating SCPI grammar from a NET API are disclosed. The discovery mechanism searches the API for metadata that specifies a SCPI grammar. If no suitable metadata exists, it will perform a best effort generation of a SCPI grammar from this API. The developer can then adjust by hand this generated SCPI grammar until the desired result is obtained. This discovered and/or generated SCPI grammar can be stored in a native SCPI grammar representation and/or in an intermediate form, such as the extensible mark-up language (XML).

The dynamic discovery of the SCPI grammar can greatly reduce the initial SCPI grammar development time required, which currently can take several months to years of development time. The developer can also associate or decorate the NET API with metadata which can aid this SCPI grammar generation. A SCPI generator first discovers one of the instrument application's NET API's. It then performs a best effort generation of a SCPI grammar using the metadata (if any) that is discovered along with the API.

While the representative embodiments disclosed herein are presented in terms of the derivation of client SCPI grammar from .NET API's, the methods are not limited to such frameworks and languages. Another language which could be used for the API's is Sun Microsystems' Java. Other current and future developed languages and frameworks having reflection capability can also be used for the API's.

In the following detailed description and in the several figures of the drawings, like elements are identified with like reference numerals.

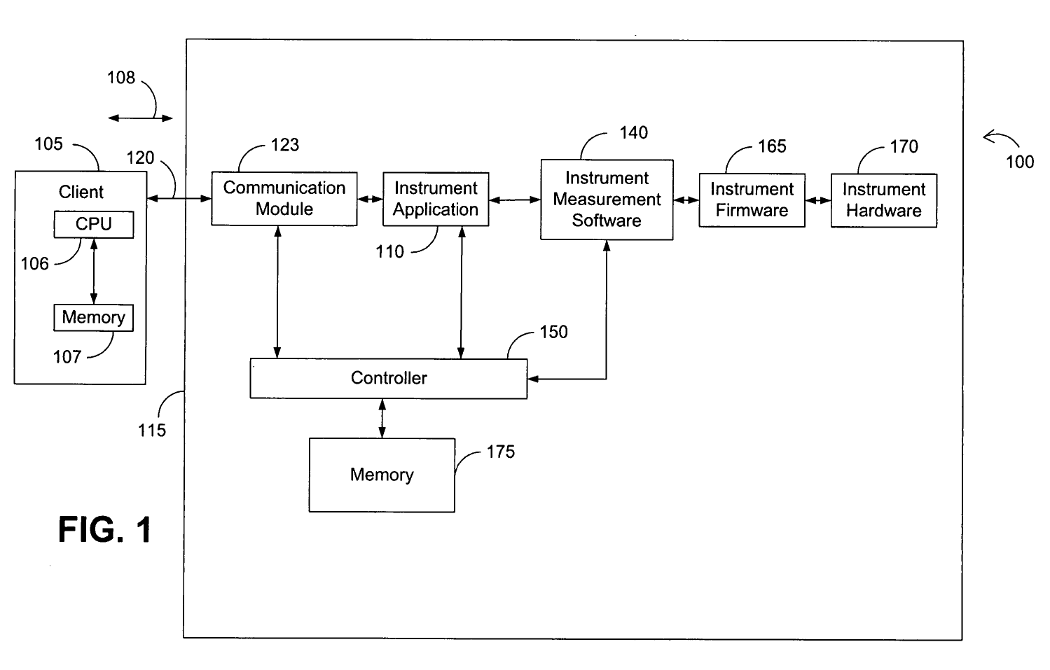

FIG. 1 is a drawing of a block diagram of a measurement system 100 as described in various representative embodiments. In the embodiment of FIG. 1, a client 105 is connected to an instrument 115 via a communication link 120 over which communications 108 can flow between the client 105 and the instrument 115. The client typically comprises a central processing unit (CPU) 106 or other control module 106 and a memory 107, also referred to herein as a memory module 107. In the instrument 115, the communication link 120 is connected to a communication module 123, also referred to herein as a communication logic module 123. Under control of a controller module 150, also referred to herein as a controller logic module 150, which is connected to another memory 175, again referred to as memory module 175, communications 108 to and from the instrument application 110, also referred to herein as an application 110 and as a .NET application 110, is translated between Standard Commands for Programmable Instrumentation (SCPI) protocol communications 108 and NET protocol communications 108.

Communications 108 controlling the functioning of the instrument 115 are generically referred to as remote procedure control (RPC) commands 108 and herein as commands 108. Before transmission RPC commands 108 are formatted by the client 105 into a SCPI protocol command 108. A number of standard sets of program calls or routines referred to as Application Program(ming) Interface (API) functions are used to control various applications on the instrument 115. The set of API functions which the application 110 on the instrument 115 has been programmed to understand are written using RPC functions or commands 108 which are resident on the instrument 115 and which are referred to as the instrument resident or instrument native API's. Similarly, the format or grammar used to write these API's is referred to as the native language of the instrument 115. The instrument native API's are formatted in conformance to an application specific protocol which could be, for example, a .NET protocol. In order to control the instrument 115, commands 108 reaching instrument measurement software 140 need to conform to the application specific protocol. The communication module 123 translates the client specific protocol commands 108 sent to the instrument 115 by the clients 105 into translated commands 108 having NET protocols which the application 110 is capable of understanding and reacting appropriately to.

In a representative implementation, the application 110 sends instructions from these translated commands 108 to the instrument measurement software 140 which in turn transfers these instructions to instrument firmware 165. The instrument firmware 165 finally transfers the required instructions to instrument hardware 170 for performing the requested task.

Standard communication protocols are used in various industries. Standard Commands for Programmable Instruments (SCPI) is one such protocol commonly used in the Test and Measurement industry. SCPI comprises a common set of commands that instruments of a particular type will understand. For example, as a general rule, voltmeters and spectrum analyzers will understand particular sets of SCPI commands which control various functions on these instruments. Instrument functionality varies depending upon instrument manufacturer and type. Product differentiation is enhanced by the manufacturer by the addition of various capabilities to the instrument. SCPI is coded as an ASCII string and has a hierarchical command structure. At the top level could be an instruction to select the general function to perform, such as measure or calibrate a subsystem or system sub-system. The next level could be a more specific statement of what the function is to perform, for example measure a frequency, voltage, or current in the item selected for measurement. Under voltage, for example, might be the type of voltage, i.e., DC voltage (direct current voltage) or AC voltage (alternating current voltage). A command might be “Measure voltage DC”. Each of these items “Measure”, “Voltage”, and “DC” are considered to be a SCPI node. The collection of all SCPI nodes in an instrument is a SCPI tree. In the instrument capable of deciphering SCPI grammar, a SCPI parser waits and listens for a SCPI command. When the SCPI parser receives a SCPI command that it understands, it identifies the correct SCPI node that corresponds to the SCPI command and instructs that node to perform the requested function.

However, not all instruments use SCPI for their resident command language API's, and computers used in the control of instruments do not always use a SCPI command set. There are potentially several different command languages that the computer can communicate with an instrument. In addition to or in place of SCPI, a computer or system often uses NET.

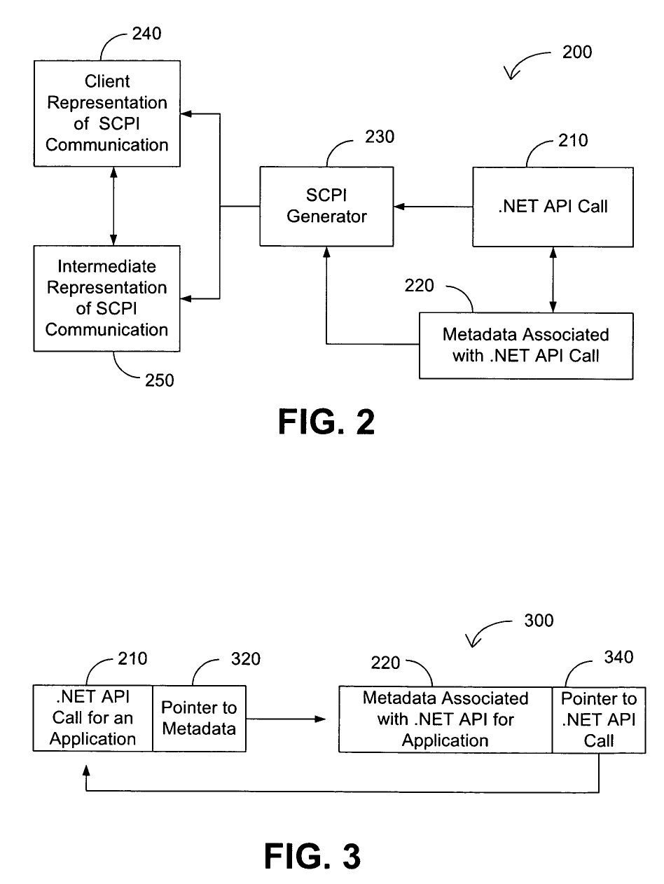

FIG. 2 is a drawing of a system 200 for the generation of Standard Commands for Programmable Instrumentation (SCPI) grammar from NET Application Programming Interface (API) calls as described in various representative embodiments. In the representative embodiment of FIG. 2, a SCPI generator 230, which is more generally referred to herein as a generator module 230, obtains a .NET API call 210 for the instrument application 110. The .NET API call 210 optionally has metadata 220 associated with it. When such associated metadata 220 is available, the SCPI generator 230 uses the combination of the NET API call 210 and the metadata 220 to automatically determine a best estimation of the SCPI communication 108 associated with the NET API call 210. When such associated metadata 220 is not available, the SCPI generator 230 uses only the .NET API call 210 to automatically determine a best estimation of the SCPI communication 108 associated with the .NET API call 210. The best estimation of the SCPI communication 108 associated with the .NET API call 210 can then be stored in an intermediate form of the SCPI communication 250, which could be for example an XML representation, or in a client representation of the SCPI communication 240.

FIG. 3 is a drawing of a block diagram of a data structure 300 as described in various representative embodiments. FIG. 3 is one possible representative embodiment of the data structure 300 associating the NET API call 210 and the metadata 220. In FIG. 3, the NET API call 210 has an associated first pointer 320 which points to the metadata 220 associated with the NET API call 210, and the metadata 220 has an associated second pointer 340 which points to the NET API call 210.

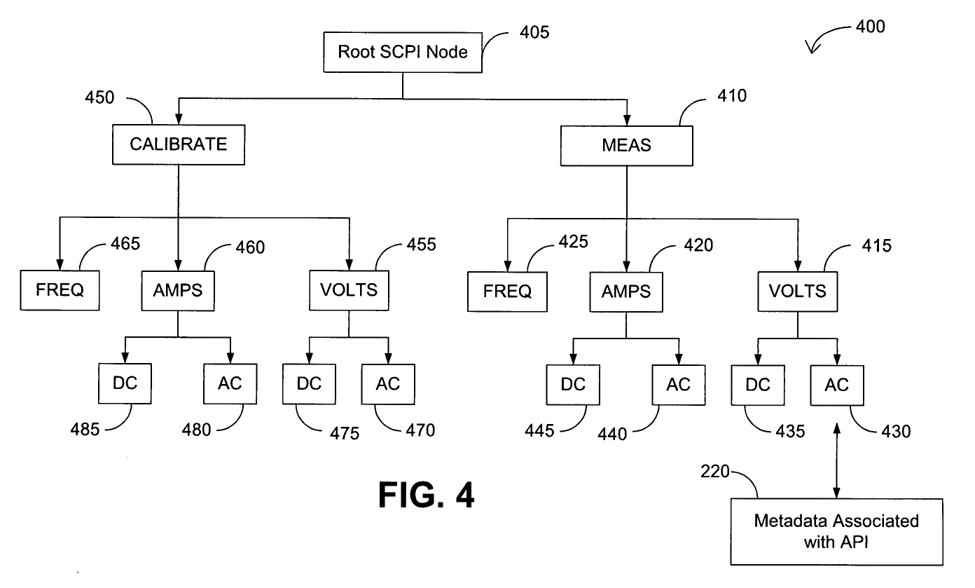

FIG. 4 is a drawing of a block diagram of another data structure 400 as described in various representative embodiments. FIG. 4 is a block diagram of a SCPI tree 400. In FIG. 4, the SCPI tree 400 comprises various SCPI nodes indicated as root SCPI node 405 which comprises child nodes CALIBRATE node 450 for calibrating various channels of the instrument and MEAS node 410 for performing measurements on various channels of the instrument.

The CALIBRATE node 450 has child nodes comprising VOLTS node 455 for calibrating voltage measurement channels, AMPS node 460 for calibrating current measurement channels, FREQ node 465 for calibrating frequency measurement channels. The VOLTS node 455 further has child nodes comprising AC node 470 for calibrating AC voltage measurement channels and DC node 475 for calibrating DC voltage measurement channels. The AMPS node 460 further has child nodes comprising AC node 480 for calibrating AC current measurement channels and DC node 485 for calibrating DC current measurement channels.

The MEAS node 410 has child nodes comprising VOLTS node 415 for measuring voltage in various measurement channels, AMPS node 420 for measuring current in various measurement channels, FREQ node 425 for measuring frequency in various measurement channels. The VOLTS node 415 further has child nodes comprising AC node 430 for measuring AC voltage in various measurement channels and DC node 435 for measuring DC voltage in various measurement channels. The AMPS node 420 further has child nodes comprising AC node 440 for measuring AC current in various measurement channels and DC node 445 for measuring DC current in various measurement channels. Metadata 220 can be optionally associated with one or more nodes of the SCPI tree 400.

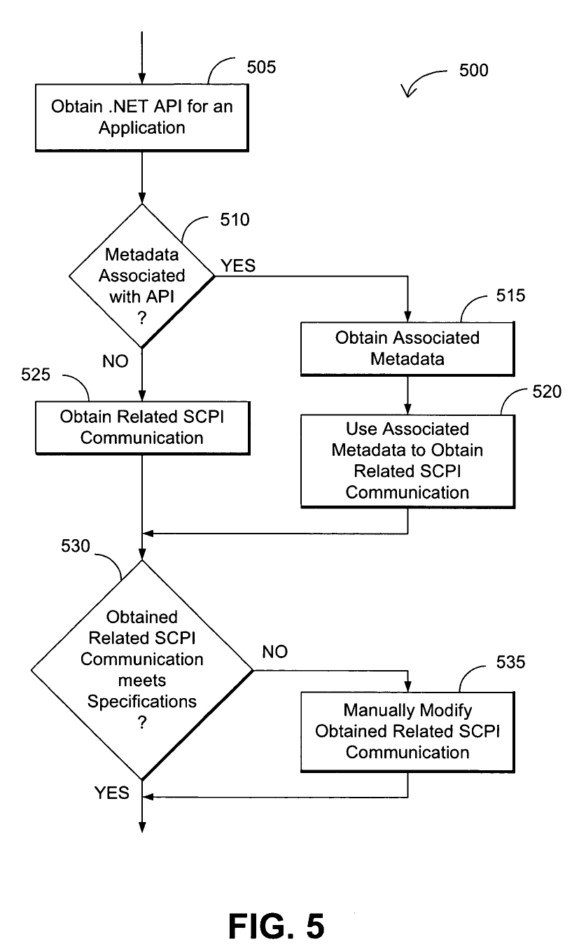

FIG. 5 is a drawing of a flow chart of a method 500 for generating Standard Commands for Programmable Instrumentation (SCPI) grammar 240,250 from NET Application Programming Interface (API) 210 calls as described in various representative embodiments. In block 505 of FIG. 5, a .NET API call 210 for an application 110 is obtained. Block 505 then transfers control to block 510.

When there is metadata 220 is associated with the NET API call 210, block 510 transfers control to block 515. Otherwise block 510 transfers control to block 525.

In block 515, metadata 220 associated with the NET API call 210 is obtained. Block 515 then transfers control to block 520.

In block 520, the .NET API call 210 and the associated metadata 220 are used to obtain the related SCPI communication 108. Block 520 then transfers control to block 530.

In block 525, the NET API call 210 is used without metadata 220 to obtain the related SCPI communication 108. Block 525 then transfers control to block 530.

When the obtained SCPI communication 108 meets SCPI specifications, block 530 terminates the process. Otherwise block 530 transfers control to block 535. The specifications against which the obtained SCPI communication 108 is evaluated could include, for example, the SCPI specification, the GPIB specification IEEE 488, or the like.

In block 535, the obtained related SCPI communication 108 is manually modified to conform to the appropriated specifications. Block 535 then terminates the process.

As a representative example of the above process, a .NET API call 210 might be as follows: “MeasureACVolts( )”. Metadata 220 associated with this call might indicate that “AC” is the mnemonic for a SCPI node corresponding to this NET “MeasureACVolts( )” method. The metadata 220 could further indicate that SCPI “VOLT” is the parent node of “AC” and that SCPI “MEAS” is the parent node of “VOLT”. From this information (.NET API call 210 and metadata 220), the corresponding SCPI communication 108 “:MEAS:VOLT:AC?” could be constructed.

As previously noted, while representative embodiments disclosed herein, including the method of FIG. 5, are presented in terms of the derivation of client SCPI grammar from NET API's, the methods are not limited to such frameworks and languages as SCPI for the protocol of client commands and NET API's for instrument control. Another language which could be used for the API's is, for example, Sun Microsystems' Java. Other current and future developed languages and frameworks having reflection capability can also be used for the API's.

As is the case, in many data-processing products, the techniques for deriving Standard Commands for Programmable Instrumentation (SCPI) protocol communications 108 from NET protocol communications 108 described herein may be implemented as a combination of hardware and software components. Moreover, the functionality needed for using such implementations may be embodied in computer-readable media, such as 3.5 inch floppy disks, conventional hard disks, DVD's, CD-ROM's, Flash ROM's, nonvolatile ROM, RAM and the like, to be used in programming an information-processing apparatus (e.g., a computer and/or instrument 115) to perform in accordance with these implementations.

The term “program storage medium” is broadly defined herein to include any kind of computer memory such as, but not limited to, floppy disks, conventional hard disks, DVD's, CD-ROM's, Flash ROM's, nonvolatile ROM, RAM, and the like.

Client 105 and developer computers, as well as instruments 115 used with the measurement system 100, can be capable of running one or more of any commercially available operating system such as DOS, various versions of Microsoft Windows (Windows 95, 98, Me, 2000, NT, XP, or the like), Apple's MAC OS X, UNIX, Linux, or other suitable operating system.

While the present invention has been described in detail in relation to representative embodiments thereof, the described embodiments have been presented by way of example and not by way of limitation. It will be understood by those skilled in the art that various changes may be made in the form and details of the described embodiments resulting in equivalent embodiment that remain within the scope of the appended claims.

1. A method for obtaining a client program grammar communication from an Application Programming Interface (API) call, comprising:
obtaining the API call;
when metadata is associated with the API call,
obtaining the associated metadata; and
automatically determining a best estimation of the client program grammar communication from the associated metadata and from the API call; and
otherwise,
automatically obtaining a best estimation of the client program grammar communication from the API call.

2. The method as recited in claim 1, wherein the API call is a .NET API call.

3. The method as recited in claim 1, wherein the client program grammar communication is a Standard Commands for Programmable Instrumentation (SCPI) communication.

4. The method as recited in claim 3, further comprising:
evaluating the obtained best estimation of the SCPI communication for conformance of the best estimation of the SCPI communication to SCPI specifications.

5. The method as recited in claim 4, further comprising:
when the obtained best estimation of the SCPI communication does not conform to SCPI specifications, manually adjusting the obtained best estimation of the SCPI communication to conform to SCPI specifications.

6. The method as recited in claim 3, further comprising:
evaluating the obtained best estimation of the SCPI communication for conformance of the best estimation of the SCPI communication to General-Purpose Interface Bus (GPIB) specifications.

7. The method as recited in claim 6, further comprising:
when the obtained best estimation of the SCPI communication does not conform to GPIB specifications, manually adjusting the obtained best estimation of the SCPI communication to conform to GPIB specifications.

8. A computer readable memory device embodying a computer program of instructions executable by the computer, the instructions comprising:
obtaining an Application Programming Interface (API) call;
when metadata is associated with the API call,
obtaining the associated metadata; and
automatically determining a best estimation of a client program grammar communication from the associated metadata and from the API call; and
otherwise,
automatically obtaining a best estimation of the client program grammar communication from the API call.

9. The computer readable memory device as recited in claim 8, wherein the API call is a .NET API call.

10. The computer readable memory device as recited in claim 8, wherein the client program grammar communication is a Standard Commands for Programmable Instrumentation (SCPI) communication.

11. The computer readable memory device as recited in claim 10, the instructions further comprising:
evaluating the obtained best estimation of the SCPI communication for conformance of the best estimation of the SCPI communication to SCPI specifications.

12. The computer readable memory device as recited in claim 11, the instructions further comprising:
when the obtained best estimation of the SCPI communication does not conform to SCPI specifications, manually adjusting the obtained best estimation of the SCPI communication to conform to SCPI specifications.

13. The computer readable memory device as recited in claim 10, the instructions further comprising:
evaluating the obtained best estimation of the SCPI communication for conformance of the best estimation of the SCPI communication to General-Purpose Interface Bus (GPIB) specifications.

14. The computer readable memory device as recited in claim 13, the instructions further comprising:
when the obtained best estimation of the SCPI communication does not conform to GPIB specifications, manually adjusting the obtained best estimation of the SCPI communication to conform to GPIB specifications.

15. A system, comprising:
a generator module configured to receive an Application Programming Interface (API) call, configured to obtain metadata when such metadata is associated with the API call, and configured to automatically determine a best estimation of the client program communication from the API call and, when such metadata has been obtained, also from the associated metadata.

16. The system as recited in claim 15, wherein the API call is a NET API call.

17. The system as recited in claim 15, wherein the client program grammar communication is a Standard Commands for Programmable Instrumentation (SCPI) communication.

18. The system as recited in claim 17, wherein the generator is further configured to evaluate the obtained best estimation of the SCPI communication with regard to conformance of the best estimation of the SCPI communication to SCPI specifications.

19. The system as recited in claim 17, wherein the generator is further configured to evaluate the obtained best estimation of the SCPI communication with regard to conformance of the best estimation of the SCPI communication to General-Purpose Interface Bus (GPIB) specifications.

20. The system as recited in claim 19, wherein GPIB specifications are specified by the Institute of Electrical and Electronic Engineers (IEEE) specification number, IEEE 488.1.
